(19) United States
(12) Patent Application Publication
(10) Pub. No.: US 2021/0286849 A1
(43) Pub. Date: Sep. 16, 2021

(54) Graphical User Interfaces for Assessment of Digital Transformation

(71) Applicant: ServiceNow, Inc., Santa Clara, CA (US)

(72) Inventors: Patricia Ann Grant, Sunnyvale, CA (US); Christopher Robert Bedi, Pleasanton, CA (US); Giovanni Servando Afable Bocao, Sunnyvale, CA (US)

(21) Appl. No.: 16/817,304

(22) Filed: Mar. 12, 2020

(51) Int. Cl. G06F 16/9038; G06F 16/904; G06F 16/906

(52) U.S. Cl. CPC G06F 16/9038; G06F 16/906; G06F 16/904

(57) ABSTRACT

A database may contain a plurality of queries and sets of predefined responses for each of the queries, the predefined responses respectively associated with numeric scores. One or more processors may be configured to: (i) generate representations of graphical user interfaces(s) including the queries with their corresponding sets of predefined responses, wherein the predefined responses of each set are presented as selectable options; (ii) receive indications of selected responses for each of the queries, the selected responses obtained by way of the selectable options; (iii) from the selected responses and the numeric scores, determine intermediate scores for each of the queries and a total score; (iv) store, in the database, the intermediate scores and the total score; and (v) generate a representation of a further graphical user interface depicting the total score, the total score emphasized to represent a range of values within which the total score is disposed.

### BACKGROUND

Digital transformation entails a number of techniques that facilitate adoption of rapidly changing digital technology to solve practical problems experienced by enterprises and other organizations. One example of digital transformation is a move toward cloud-based services, which can reduce an enterprise's need to deploy and maintain its own hardware and software. Another example is automation, where routine tasks can be carried out as a whole or in part by software rather than manually. Yet another example is the paperless office, a term referring to how organizations can move most transactions online, eliminating a vast number of physical records.

But digital transformation is more than just moving services from one place to another or replacing human labor with computing cycles. It involves employing new innovations and solutions on an ongoing basis, often by way of complex technologies, in different areas of an enterprise. In some ways, it represents cultural changes as well as technological changes.

Nonetheless, digital transformation has proven difficult to understand, much less deploy. A successful digital transformation may involve use of a variety of software tools (e.g., online document repositories, authentication and authorization hierarchies, machine learning), as well as new procedures with which to carry out tasks. Further, the implementation details and processes may vary from enterprise to enterprise. As a consequence, most enterprises lack the means with which to assess their readiness, status, or best practices for digital transformation.

### SUMMARY

The embodiments herein provide a set of new graphical user interfaces that can be used to collect user feedback and other information regarding the state of enterprise deployment, execution, and readiness for digital transformation. These interfaces allow a user to answer a set of queries from three domains—velocity (level of execution speed), intelligence (level of data availability and quality), and experience (level of customization and personalization). The queries are specifically curated to elicit responses that are highly relevant to predicting the enterprise's digital maturity.

Intermediate scores are associated with responses to these queries, and can be used to determine a per-domain score and/or a total digital maturity score. From this total score itself, as well as comparisons of the total scores of various organizations and functions within an enterprise, areas that are candidates for improvement can be rapidly determined. These total scores may be presented on a heat map for easy visualization of relative digital maturities. Unlike most efforts at digital transformation, which rarely go beyond the buzzword phase, the embodiments herein allow the enterprise to leverage its existing digital investments and identify benefits of further digital transformation in a fashion that is descriptive and actionable.

Accordingly, a first example embodiment may involve a database containing a plurality of queries and sets of predefined responses for each of the queries, wherein the predefined responses are respectively associated with numeric scores. The first example embodiment may also involve one or more processors configured to: (i) generate, for display on a client device, representations of one or more graphical user interfaces including the queries with their corresponding sets of predefined responses, wherein the predefined responses of each set are presented as mutually exclusive selectable options in graphical elements; (ii) transmit, to the client device, the representations of the one or more graphical user interfaces; (iii) receive, from the client device, indications of selected responses for each of the queries, wherein the selected responses were obtained by way of the mutually exclusive selectable options; (iv) from the selected responses and the numeric scores, determine intermediate scores for each of the queries; (v) based on the intermediate scores for each of the queries, determine a total score; (vi) store, in the database, the intermediate scores for each of the queries and the total score; (vii) generate, for display on the client device, a further representation of a further graphical user interface depicting the total score, wherein the total score is emphasized in a fashion that represents a range of numeric values within which the total score is disposed; and (viii) transmit, to the client device, the further representation of the further graphical user interface.

A second example embodiment may involve obtaining, from a database, a plurality of queries and sets of predefined responses for each of the queries, wherein the predefined responses are respectively associated with numeric scores. The second example embodiment may further involve generating, for display on a client device, representations of one or more graphical user interfaces including the queries with their corresponding sets of predefined responses, wherein the predefined responses of each set are presented as mutually exclusive selectable options in graphical elements. The second example embodiment may further involve transmitting, to the client device, the representations of the one or more graphical user interfaces. The second example embodiment may further involve receiving, from the client device, indications of selected responses for each of the queries, wherein the selected responses were obtained by way of the mutually exclusive selectable options. The second example embodiment may further involve, from the selected responses and the numeric scores, determining intermediate scores for each of the queries. The second example embodiment may further involve, based on the intermediate scores for each of the queries, determining a total score. The second example embodiment may further involve storing, in the database, the intermediate scores for each of the queries and the total score. The second example embodiment may further involve generating, for display on the client device, a further representation of a further graphical user interface depicting the total score, wherein the total score is emphasized in a fashion that represents a range of numeric values within which the total score is disposed. The second example embodiment may further involve transmitting, to the client device, the further representation of the further graphical user interface.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts four levels of digital maturity for each of three domains, in accordance with example embodiments.

FIG. 6B depicts four levels of digital maturity for each of three domains in a specific area, in accordance with example embodiments.

FIG. 7 depicts a digital transformation lifecycle, in accordance with example embodiments.

FIG. 8 depicts a graphical user interface representation of a digital maturity heat map, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

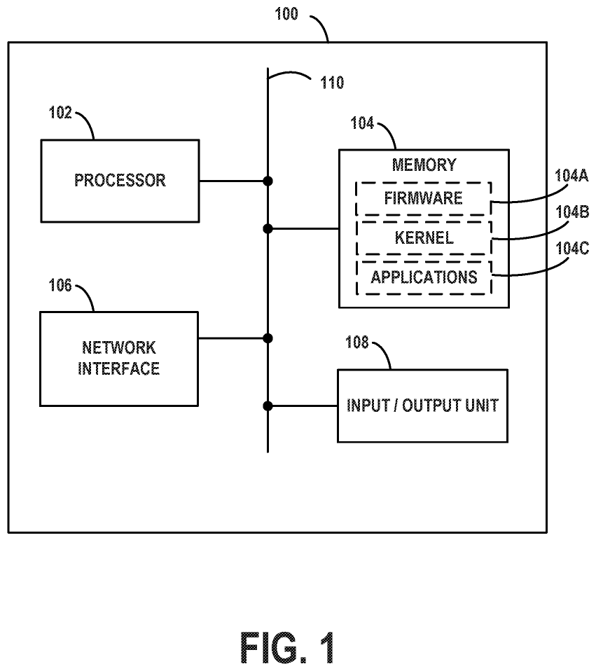

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

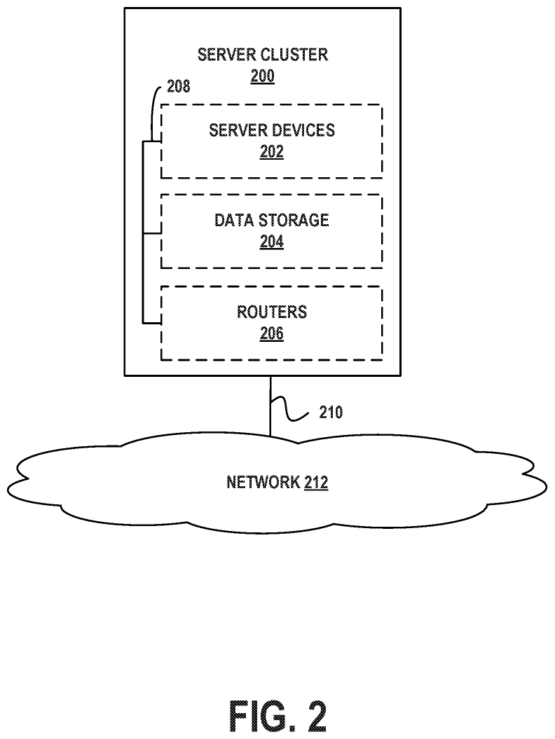

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

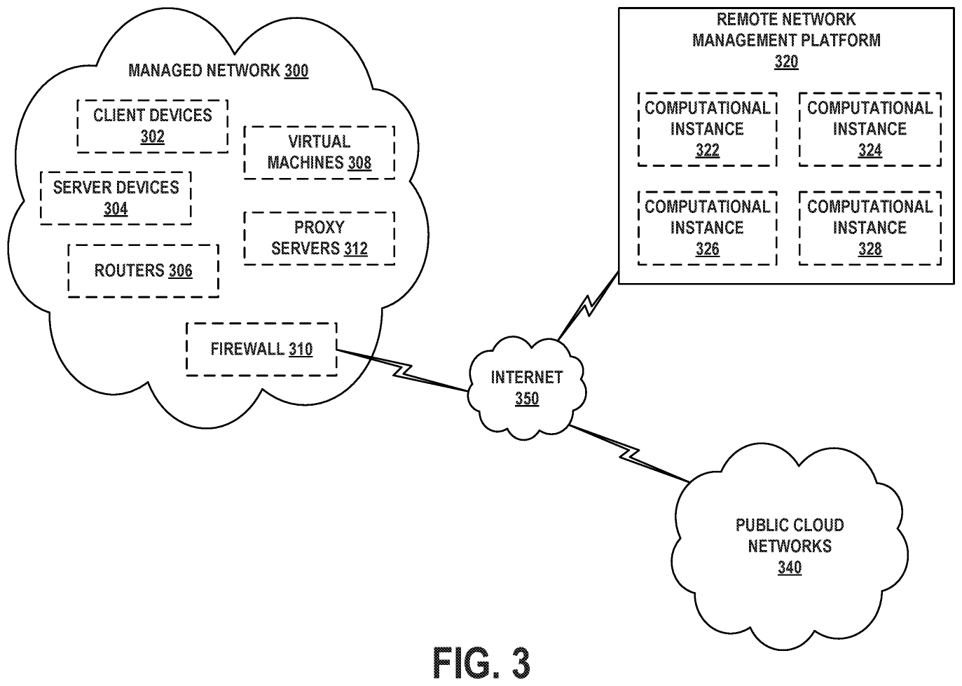

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

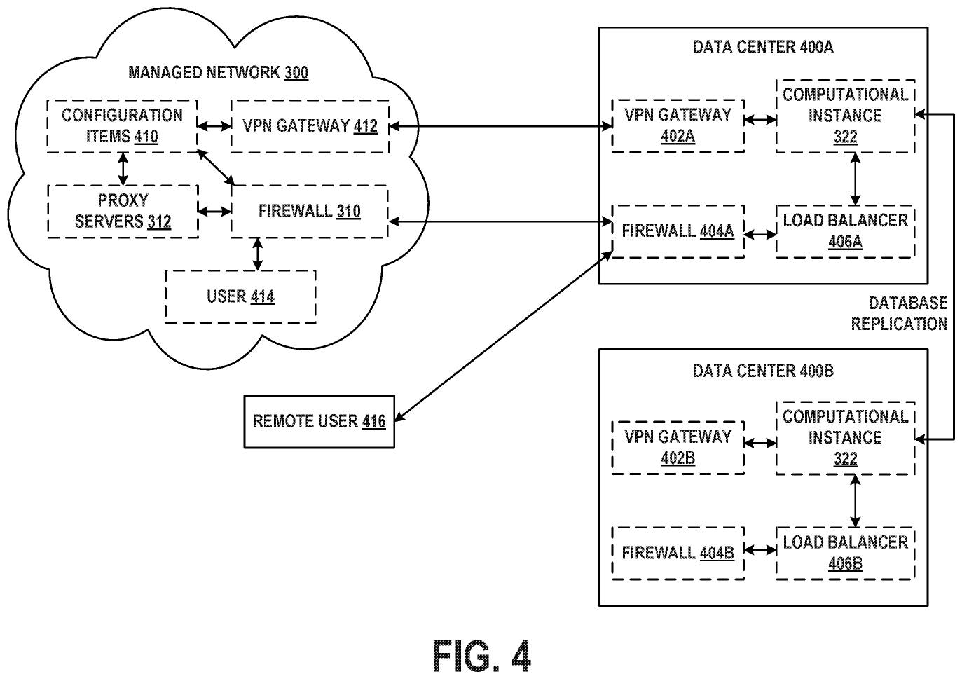

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

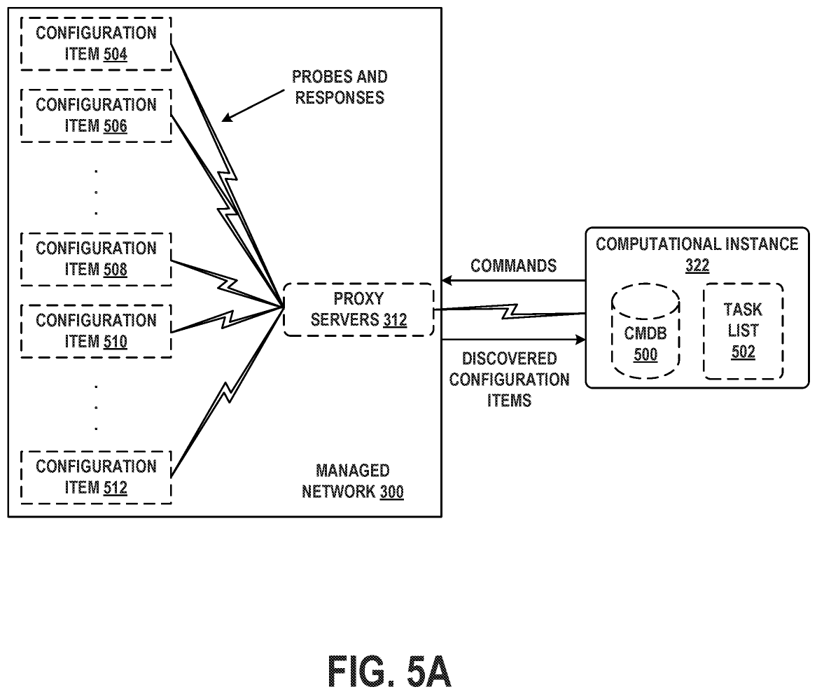

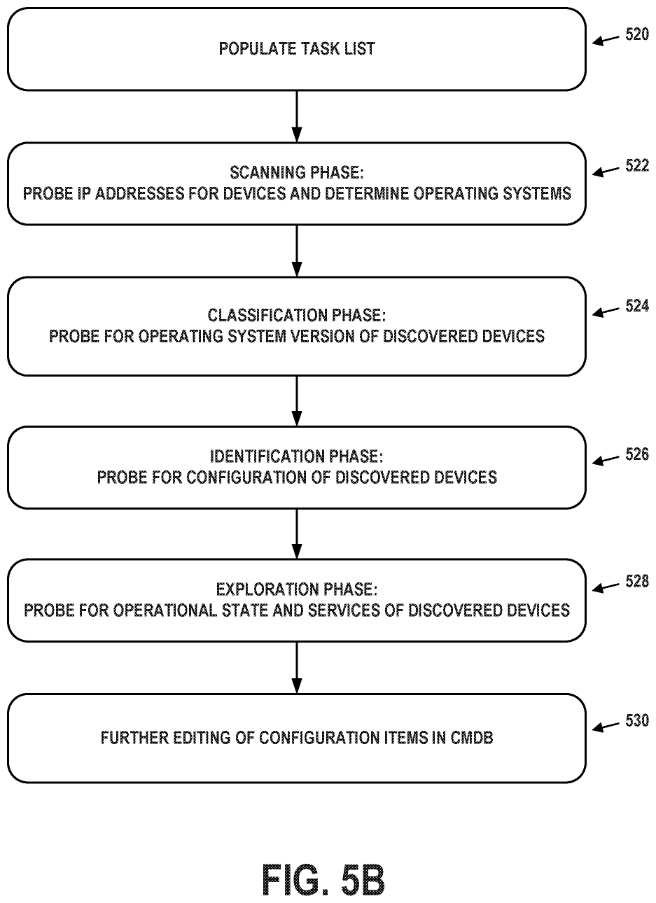

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Digital Transformation Framework

Digital transformation involves the integration of digital technology into some or all areas of an enterprise, fundamentally changing how the enterprise operates and delivers products and services to both internal and external customers. Digital transformation also represents a cultural change, with which operations are continuously evaluated and updated through use of data analytics, software, and other technologies.

But in practice, digital transformation has been difficult to define, much less implement successfully. Given the breadth of the term, it can mean different things to different people and organizations, and a successful digital transformation is likely to be carried out differently in each organization. As a consequence, many enterprises are attempting to embrace the move toward digitization, but with a scattershot approach that is not based on objective evaluations of their current level of digital maturity and does not identify the most favorable candidates for transformation.

The embodiments herein leverage the remote network management platform capabilities described above to provide an objective, structured, and focused approach to digital transformation. Enterprise capabilities, technologies, and needs are characterized by user-provided responses to a set of queries. These queries are dividing into three domains—velocity (level of execution speed), intelligence (level of data availability and quality), and experience (level of customization and personalization). The queries have been designed to elicit responses that are insightful and predictive of the enterprise's digital maturity.

From the responses to these queries, a digital score is produced. An algorithm applies predetermined weights to the responses, allowing tailoring of their relative importance. Scores from different aspects or areas within the enterprise can be compared on a graphical user interface, perhaps in the form of a heat map. Doing so provides for easy visualization of digital maturities across the enterprise. This results in a simple, visual tool that can identify areas that are most likely to benefit from specific digital transformation initiatives.

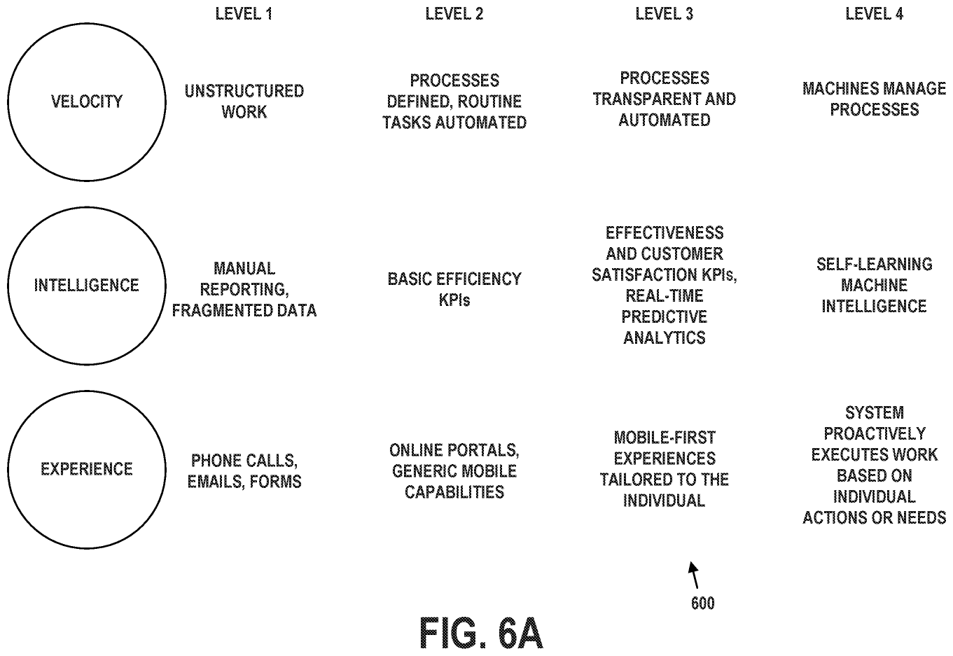

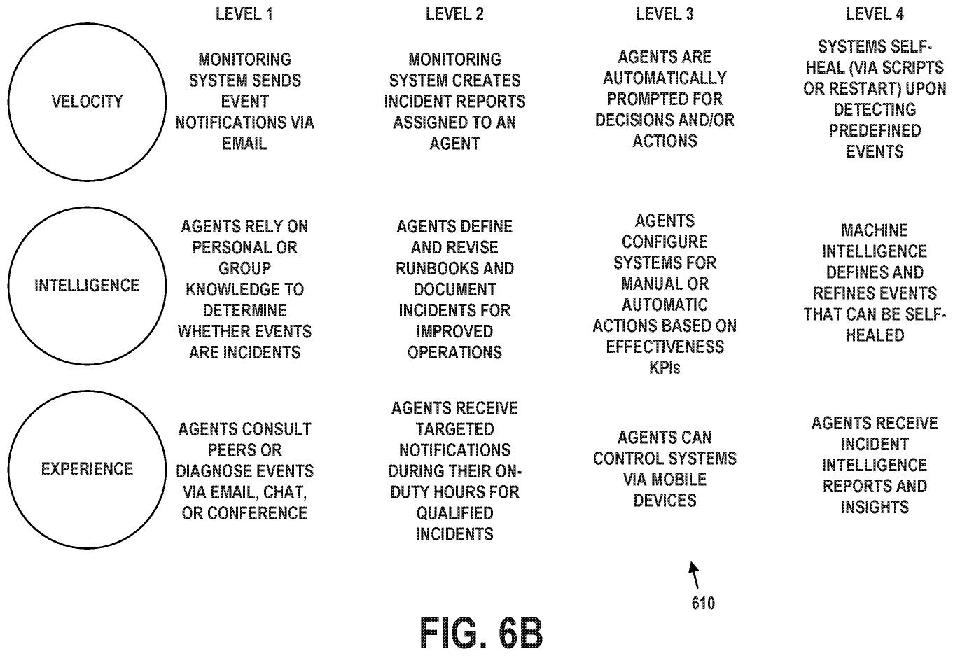

An example representation 600 of general digital transformation maturity levels is depicted in FIG. 6A. Each domain's maturity is characterized in terms of four levels, with level 1 being the lowest, least mature stage, and level 4 being the highest, most mature stage. For all domains, an increase in level represents more automation and machine intelligence (e.g., artificial intelligence/machine learning) being applied to the domain. Each subsequent level builds upon the previous level, incorporating, replacing or improving upon the maturity indicators therein.

For the velocity domain, level 1 represents unstructured work, where tasks are assigned and carried out on an ad hoc basis with little or no organization or strategy. At level 2, processes have been defined and some routine tasks have been automated, but a majority of the work is still manual. At level 3, the processes are transparent (i.e., well-known and understood by stakeholders) and automation of these processes is complete or nearly complete. At level 4, processes are managed by machine intelligence, including modifications and updates to these processes.

For the intelligence domain, level 1 represents manual reporting and data that is fragmented and/or unorganized. At level 2, key performance indicators (KPIs) for basic process efficiency are available. At level 3, KPIs for process effectiveness and customer satisfaction are available, as are real-time predictive analytics. At level 4, machine intelligence is able to take in structured data and make predictions and recommendations.

For the experience domain, level 1 represents communication by way of phone calls, emails, and forms. At level 2, online portals and services with support for generic mobile capabilities are in place. At level 3, mobile-oriented interfaces with user experiences tailored to individuals are used. At level 4, the system proactively executes work based on individual actions or needs.

While FIG. 6A depicts three domains with four levels each, the embodiments herein may be used with more or fewer domains and more or fewer levels. Thus, the depiction in FIG. 6A is for purposes of example.

FIG. 6B provides a concrete illustration 610 of each of the four levels of the three domains for an incident management function of an enterprise. Incident reports are often opened by IT users to describe a problem that they have experienced. Each incident report may also be referred to as a record. Incident reports may be created in various ways—in some cases, by way of a web form, an email sent to a designated address, a voicemail box using speech-to-text conversion, and so on. These incident reports may be stored in an incident report database or table therein that can be queried. As an example, a query in the form of a text string could return one or more incident reports that contain the words in the text string. Submitted incident reports are assigned to an individual agent (or group of agents) who is tasked with resolving the incident.

For the velocity domain, level 1 represents a monitoring system that detects events (e.g., indicating that certain devices are not working properly) and sends event notifications (e.g., alarms) via email. At level 2, the monitoring system automatically creates incident reports based on detected events and assigns these to an agent (or group of agents). At level 3, the monitoring system automatically prompts agents for decisions and/or actions on their incidents. At level 4, systems self-heal (e.g., through scripts or restarts) upon detecting predefined events.

For the intelligence domain, level 1 represents agents relying on personal or group knowledge to determine whether events are incidents. At level 2, agents define and revise their own runbooks (a runbook is a set of procedures and/or operations that an agent carries out in order to diagnose or address incidents), as well as document incidents in order to improve operations. At level 3, agents configure systems for manual or automatic action based on known effectiveness KPIs. At level 4, machine intelligence defines and refines events that can be self-healed.

For the experience domain, level 1 represents agents consulting peers or diagnosing events via email, chat, or conferences. At level 2, agents receive targeted notifications during their on-duty hours for certain qualified incidents. At level 3, agents can control systems by way of mobile devices. At level 4, agents proactively receive intelligence reports and insights regarding the operation of systems.

Clearly, it is desirable for an enterprise to advance (from level 1 to level 2, from level 2 to level 3, etc.) in each of the three domains. In an ideal situation, the enterprise is as close to reasonably possible to level 4 (or whatever the highest level might be) in these domains for each of the enterprise's functions. The first step to achieve this goal is to perform an assessment of the organization's current digital maturity for these domains.

In the past, such assessments have been ad hoc and subjective. The embodiments herein involve, for each enterprise function, a set of specific queries directed to each domain. Responses to these queries can be converted to numeric form, weighted, and combined in various ways to provide an overall digital maturity score as well as domain-specific scores for the enterprise's performance of that function. These scores can be mapped to one of the four respective levels based upon assigning ranges of score values to a level. Review of the scores provides particular, actionable recommendations of initiatives that the enterprise can undertake in order to improve its digital maturity. The following subsections consider queries applicable to each domain and how responses are scored.

A. Velocity

As noted above, velocity represents execution speed of the processes for an enterprise function. Table 1 provides a list of velocity-related queries, selectable responses, and scores associated with each possible answer.

TABLE 1
Velocity Queries, Responses, and Scores

| Query | Selectable Responses | Scores |
|---|---|---|
| 1. Identify the level that best | Ad hoc or reactive | 0 |
| represents the maturity of this | Consistent or repeatable | 20 |
| process | Published and standardized | 70 |
| | Measured and controlled | 85 |
| | Continuously optimized | 100 |
| 2. How much human effort is | Completely manual | 0 |
| needed to perform this | 25% automated | 25 |
| process? | 50% automated | 50 |
| | 75% automated | 75 |
| | Zero touch/Full automation | 100 |
| 3. List the systems and | N/A | N/A |
| applications involved in | | |
| performing this process | | |

These queries may be presented to an individual one at a time or in groups by way of one or more graphical user interface(s). For each query, the respective selectable responses might appear in a dropdown menu, as radio buttons, or in some other form. For instance, the selectable responses of query 2 in Table 1 may appear as mutually exclusive options of a drop down menu, labeled as “Completely manual”, “25% automated”, “50% automated”, “75% automated”, and “Zero touch/Full automation”, respectively.

Based on the responses selected, a score is provided. The scores in Table 1 are from 0 to 100, but other ranges may be used. In some embodiments, different responses may have scores using different ranges. Further, non-integer ranges can be used. In some cases, responses are free-form and not selected from a menu; thus, in these cases, no score is provided.

Regardless, a category score, S_{V}, can be calculated as a function of the individual (intermediate) scores for each of the queries. Thus, if there are n velocity-related queries with scores and sᵥⁱ represents the score of velocity answer i, then:

S_{V}=f_{V}(s_{V}¹,s_{V}², . . . ,s_{V}ⁿ)

The exact definition of f_{V} may vary. In some embodiments, f_{V} may be an average or weighted average. Therefore:

$${S}_{V} = {f}_{V} ( {s}_{V}^{1} , {s}_{V}^{2} , … , {s}_{V}^{n} ) = \frac{1}{n} ( {\sum }_{1}^{n} {s}_{V}^{i} )$$

$$or$$

$${S}_{V} = {f}_{V} ( {s}_{V}^{1} , {s}_{V}^{2} , … , {s}_{V}^{n} ) = \frac{1}{n} ( {\sum }_{1}^{n} {s}_{V}^{i} {w}_{V}^{i} )$$

where 0≤w_{V}ⁱ≤1, for example. Other possibilities exist.

As an example of S_{V} being an average, if the answer “Consistent or repeatable” was selected for query 1 and the answer “75% automated” was selected for query 2, then s_{V}¹=20 and S_{V}²=75. Therefore, in this case, S_{V}=½(20+75)=47.5.

B. Intelligence

As noted previously, intelligence represents how much data regarding the process is available, how it is being used, and its perceived accuracy. Table 2 provides a list of intelligence-related queries, selectable responses, and scores associated with each possible answer.

TABLE 2
Intelligence Queries, Responses, and Scores

| Query | Selectable Responses | Scores |
|---|---|---|
| 1. Do you have data | No | 0 |
| available to measure | Yes, mostly in spreadsheets | 25 |
| this process? | Yes, in standalone apps or systems | 60 |
| | Yes, in a real-time centralized data | 100 |
| | platform | |
| 2. How are you using | Don't know | 0 |
| this data? | Used for ad-hoc reports and metrics | 25 |
| | Used for dashboards and historical | 50 |
| | reporting | |
| | Used for automated recommendations, | 75 |
| | insights, forecasts | |
| | Used for automated decisions and | 100 |
| | actions | |
| 3. Do you trust this | No | 0 |
| data to be the basis | Somewhat | 40 |
| of decision making? | Yes | 100 |

These queries may be presented to an individual one at a time or in groups by way on or more graphical user interfaces. For each query, the respective selectable responses might appear in a dropdown menu, as radio buttons, or in some other form. For instance, the selectable responses of query 1 in Table 2 may appear as mutually exclusive options of a drop down menu, labeled as “Don't know”, “Used for ad-hoc reports and metrics”, “Used for dashboards and historical reporting”, “Used for automated recommendations, insights, forecasts”, and “Used for automated decisions and actions”, respectively.

Based on the responses selected, a score is provided. The scores in Table 2 are from 0 to 100, but other ranges may be used. In some embodiments, different responses may have scores using different ranges. Further, non-integer ranges can be used. In some cases, responses are free-form and not selected from a menu; thus, in these cases, no score is provided.

Regardless, a category score, S_{I}, can be calculated as a function of the individual (intermediate) scores for each of the queries. Thus, if there are n intelligence-related queries with scores and 4 represents the score of intelligence answer i, then:

S_{I}=f_{I}(s_{I}¹,s_{I}², . . . ,s_{I}ⁿ)

The exact definition of f_{I} may vary. In some embodiments, f_{I} may be an average or weighted average. Therefore:

$${S}_{I} = {f}_{I} ( {s}_{I}^{1} , {s}_{I}^{2} , … , {s}_{I}^{n} ) = \frac{1}{n} ( {\sum }_{1}^{n} {s}^{i} )$$

$$or$$

$${S}_{I} = {f}_{I} ( {s}_{I}^{1} , {s}_{I}^{2} , … , {s}_{I}^{n} ) = \frac{1}{n} ( {\sum }_{1}^{n} {s}_{I}^{i} {w}_{I}^{i} )$$

where 0≤w_{I}ⁱ≤1, for example. Other possibilities exist.

As an example of S_{I} being based on an average, if the answer “Yes, mostly in spreadsheets” was selected for query 1, the answer “Used for automated recommendations, insights, forecasts” was selected for query 2, and the answer “Somewhat” was selected for query 3, then s_{I}¹=25, s_{I}²=75, and s_{I}³=40. Therefore, in this case,

$${S}_{I} = \frac{1}{3} ( 25 + 75 + 40 ) = 46.7 .$$

C. Experience

As noted previously, experience represents level of customization and personalization of the process, as well as feedback from end users. Table 3 provides a list of experience-related queries, selectable responses, and scores associated with each possible answer.

TABLE 3
Experience Queries, Responses, and Scores

| Query | Selectable Responses | Scores |
|---|---|---|
| 1. What is the level of | No personalization required | N/A |
| personalization that | Limited (e.g., employee vs. | 25 |
| this process offers? | contractor) | |
| | Intermediate (e.g., employee in the | 50 |
| | U.S. vs. Japan) | |
| | Advanced (e.g., employee is IT | 100 |
| | project manager in India vs. sales | |
| | executive in Australia) | |
| 2. What is the | Not a consumer-facing process | N/A |
| consumer | Via emails and/or phone calls | 25 |
| engagement for | Via emails, phone calls, website, portal, | 75 |
| this process? | and/or desktop application | |
| | Via emails, phone calls, website, portal, | 100 |
| | desktop application, mobile application, | |
| | and/or virtual assistant with a seamless | |
| | omni-channel hand-off | |
| 3. How does the | Not a consumer-facing process | N/A |
| consumer rate this | Experience not tracked | 0 |
| process? | Bad experience | 0 |
| | Meets needs | 40 |
| | Easy and engaging | 75 |
| | Proactive | 100 |
| 4. How does the | Experience not tracked | 0 |
| fulfiller rate | Bad experience | 0 |
| this process? | Meets needs | 40 |
| | Easy and engaging | 75 |
| | Proactive | 100 |

These queries may be presented to an individual one at a time or in groups by way of one or more graphical user interfaces. For each query, the respective selectable responses might appear in a dropdown menu, as radio buttons, or in some other form. For instance, the selectable responses of query 4 in Table 3 may appear as mutually exclusive options of a drop down menu, labeled as “Experience not tracked”, “Bad experience”, “Meets needs”, “Easy and engaging”, and “Proactive”, respectively.

Based on the responses selected, a score is provided. The scores in Table 3 are from 0 to 100, but other ranges may be used. In some embodiments, different responses may have scores using different ranges. Further, non-integer ranges can be used. In some cases, responses are free-form and not selected from a menu; thus, in these cases, no score is provided. In other cases, some responses are not associated with a score.

Regardless, a category score, S_{E}, can be calculated as a function of the individual (intermediate) scores for each of the queries. Thus, if there are n experience-related queries with scores and s_{E}ⁱ represents the score of experience answer i, then:

S_{E}=f_{E}(s_{E}¹,s_{E}², . . . ,s_{E}ⁿ)

The exact definition of f_{E} may vary. In some embodiments, f_{E} may be an average or weighted average. Therefore:

$${S}_{E} = {f}_{E} ( {s}_{E}^{1} , {s}_{E}^{2} , … , {s}_{E}^{n} ) = \frac{1}{n} ( {\sum }_{1}^{n} {s}_{E}^{i} )$$

$$or$$

$${S}_{E} = {f}_{E} ( {s}_{E}^{1} , {s}_{E}^{2} , … , {s}_{E}^{n} ) = \frac{1}{n} ( {\sum }_{1}^{n} {s}_{E}^{i} {w}_{E}^{i} )$$

where 0≤w_{E}ⁱ≤1, for example. Other possibilities exist.

As an example of S_{E} being based on an average, if the answer “Intermediate” was selected for query 1, the answer “Via emails and/or phone calls” was selected for query 2, the answer “Meets my needs” was selected for query 3, and the answer “Easy and engaging” was selected for query 4, then s_{E}¹=50, s_{E}²=25, and s_{E}³=40, and 4=75. Therefore, in this case,

$${S}_{E} = \frac{1}{4} ( 50 + 25 + 40 + 75 ) = 47.5 .$$

D. Process Frequency

In certain embodiments, additional queries that do not belong to one of the three domains may take into account other factors. As one possible factor, a process frequency may be considered. This query and its possible responses are shown in Table 4.

TABLE 4
Process Frequency Queries, Responses, and Scores

| Query | Selectable Responses | Scores |
|---|---|---|
| 1. Estimate how often is the | <100 | 100 |
| process performed annually | 100-500 | 75 |
| | 501-1000 | 50 |
| | 1001-5000 | 25 |
| | >5000 | 0 |

This query characterizes how often a process is performed, with the understanding that processes performed more frequently are often better candidates (i.e., “low-hanging fruit”) for digital maturity improvements than processes performed less frequently. The query may be presented to an individual by way of a graphical user interface. The selectable responses might appear in a dropdown menu, as radio buttons, or in some other form. For instance, the selectable responses of query 1 in Table 4 may appear as mutually exclusive options of a drop down menu, labeled as “<100”, “100-500”, “501-1000”, “1001-5000”, and “>5000”, respectively.

Based on the responses selected, a score, S_{M}, is provided. The scores in Table 4 are from 0 to 100, but other ranges may be used. In some embodiments, different responses may have scores using different ranges. Further, non-integer ranges can be used. In some cases, responses are free-form and not selected from a menu; thus, in these cases, no score is provided. In other cases, some responses are not associated with a score.

E. Total Digital Maturity Score

Based on the individual scores determined for the velocity, intelligence, and experience domains (and possibly frequency as well), a total digital maturity score, S, may be obtained. This score may be a function of S_{V}, S_{I}, S_{E}, and S_{M}. Thus, for example:

S=g(S_{V},S_{I},S_{E},S_{M})

In some cases this function, g, may be an average, weighted average, or some other linear or non-linear function of S_{V}, S_{I}, S_{E}, and S_{M}. It is possible that weights of zero can be applied to certain scores to effectively eliminate those scores from the calculation. For example, if S_{M} is not available, it may be given a weight of zero.

One possible embodiment of g that has proven beneficial in practice is:

$$S = g ( {S}_{V} , {S}_{I} , {S}_{E} , {S}_{M} ) = 0.9 \times \frac{1}{3} ( {S}_{V} + {S}_{I} + {S}_{E} ) + 0.1 \times {S}_{M}$$

In words, this equation calculates S based on the average of S_{V}, S_{I}, and S_{E} weighted by 0.9 and the value of S_{M} weighted by 0.1. Thus, in line with the examples above, S takes on a value between 0 and 100, inclusive. Nonetheless, other calculations and ranges of values for S may be possible.

TABLE 5
Mapping of Digital Maturity Scores to Levels

| S | Level |
|---|---|
| 0 ≤ S ≤ 25 | 1 |
| 25 < S ≤ 50 | 2 |
| 50 < S ≤ 75 | 3 |
| 75 < S ≤ 100 | 4 |

Regardless of the range that is ultimately used, this range may be divided into a number of non-overlapping subranges representing levels of digital maturity. In some embodiments, there may be four subranges representing the four levels of digital maturity discussed in the context of FIGS. 6A and 6B, and shown in Table 5. For example, values of S can be mapped to levels in accordance with the examples in Table 5 or in other ways. Once a level is established, this level can be represented in an associated text or background color on a graphical user interface to make it easy to differentiate where an enterprise has higher and lower levels of digital maturity. Example graphical user interfaces are discussed below.

F. Cyclic Evaluation

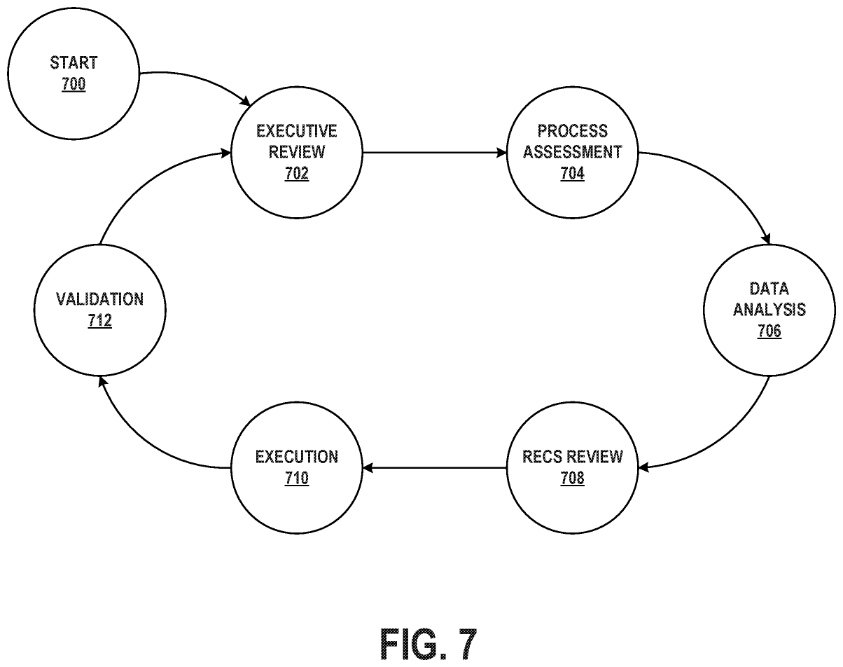

Digital maturity assessments are not intended to be performed just once. They should be carried out regularly in order to have a continuous and up to date evaluation of the enterprise's progress. The cyclic flow chart of FIG. 7 depicts how digital maturity assessments can be repeated in a structured and orderly fashion.

At block 700, the initial assessment begins. This step occurs when an enterprise determines that it is desirable to undertake digital transformation in a measurable and actionable fashion.

At block 702, executive review takes place. This involves identifying executive stakeholders and service owners, as well as holding kick-off session with these individuals and groups.

At block 704, process assessment takes place. This involves holding walk-throughs with service owners and lead analysts, as well as cataloging relevant processes using a digital framework template that maps to the queries and responses presented above.

At block 706, data analysis takes place. This involves normalizing data and complete assessments with lead analysts, as well as generating digital maturity insights and recommendations therefrom. For example, recommendations may be made for enterprise functions that have digital maturity scores of less than 50.

At block 708, recommendation review takes place. This may involve reviewing the recommendations with executive stakeholders and service owners, as well as calibrating recommendations against an executive roadmap or other pre-established goals.

At block 710, execution takes place. This may involve assigning and prioritizing workloads into appropriate work streams, as well as executing the recommendations.

At block 712, validation may take place. This may involve capturing value realized from executed projects, as well as holding monthly review sessions with program leaders and lead analysts.

From block 712, the cycle repeats with a reassessment beginning once again with executive review at block 702. This cycle may repeat any number of times. In some cases, certain blocks may be skipped or combined with one another and/or performed out of order with respect to FIG. 7.

### VI. Proactive Recommendations

In addition to the digital maturity assessments determining various levels of digital maturity for each of the three domains, the embodiments herein may make proactive recommendations of specific steps that can be taken to achieve a higher level of digital maturity. Tables 6, 7, and 8 provide examples of such recommendations. But in various embodiments, more or less detailed recommendations may be made.

TABLE 6
Velocity Recommendations

| Query | Selectable Responses | Recommendations |
|---|---|---|
| 1. Identify the | Ad hoc or reactive | Design and document your |
| level that best | Consistent or | process including governance |
| represents the | repeatable | and data requirements. |
| maturity of | Published and | Use a combination of process |
| this process | standardized | re-engineering, process- |
| | Measured and | mining, and ongoing |
| | controlled | performance. |
| | Continuously | N/A |
| | optimized | |
| 2. How much | Completely manual | Start your automation |
| human effort is | | journey with basic workflows |
| needed to | | and catalog items. |
| perform this | 25% automated | Leverage advanced |
| process? | 50% automated | technologies such as |
| | | robotic process |
| | | automation to automate |
| | | repeated activities. |
| | 75% automated | Leverage process mining to |
| | | optimize your workflows. |
| | Zero touch/Full | N/A |
| | automation | |
| 3. List the | N/A | N/A |
| systems and | | |
| applications | | |
| involved in | | |
| performing this | | |
| process | | |

As shown in Table 6, when a user provides a response of “Ad hoc or reactive” or “Consistent or repeatable” to query 1, the system makes a recommendation of “Design and document your process including governance and data requirements.” Likewise, if the user provides a response of “Published and standardized” or “Measured and controlled” to query 1, the system makes a recommendation of “Use a combination of process re-engineering, process-mining, and ongoing performance.” A recommendation of “N/A” is used when the response indicates the highest level of digital maturity or a recommendation is otherwise not relevant.

Similar recommendations are provided in Tables 7 and 8, below, for the intelligence and experience domains, respectively. As a whole, the recommendations provide the user with specific, concrete actions that can be taken to improve digital maturity. Such an ability has been lacking in legacy systems.

TABLE 7
Intelligence Recommendations

| Query | Selectable Responses | Recommendations |
|---|---|---|
| 1. Do you | No | Data collection and |
| have data | | availability is a key step to |
| available | | building intelligence into a |
| to measure | | process. Start gathering data |
| this process? | | in a data storage application. |
| | Yes, mostly in | Migrate to a centralized data |
| | spreadsheets | platform or consider using |
| | Yes, in standalone | tools that allow data sharing, |
| | apps or systems | updates and analyses in a |
| | | secure manner. |
| | Yes, in a real-time | N/A |
| | centralized data | |
| | platform | |
| 2. How are | Don't know | Get to more consistent reports |
| you using | Used for ad-hoc reports | that can be used to make data- |
| this data? | and metrics | driven decisions in the future. |
| | Used for dashboards | Streamline using analytics and |
| | and historical reporting | supervised machine learning |
| | Used for automated | to generate recommendations. |
| | recommendations, | |
| | insights, forecasts | |
| | Used for automated | N/A |
| | decisions and actions | |
| 3. Do you trust | No | Understand the source of the |
| this data to be | | data and build preliminary |
| the basis of | | data quality checks to |
| decision | | improve data governance. |
| making? | Somewhat | Assess data quality |
| | | extensively. |
| | | Ensure high-quality data |
| | | integration using |
| | | identification, alignment |
| | | of units of measure and |
| | | data definitions and de- |
| | | duplication. |
| | Yes | N/A |

TABLE 8
Experience Recommendations

| Query | Selectable Responses | Recommendations |
|---|---|---|
| 1. What is | No personalization required | N/A |
| the level of | Limited (e.g., employee vs. | Define personas. Get |
| personalization | contractor) | to a more personalized |
| that this | Intermediate (e.g., employee | experience for the |
| process offers? | in the U.S. vs. Japan) | process by increasing |
| | | the focus on the |
| | | personas involved. |
| | Advanced (e.g., employee is | N/A |
| | IT project manager in India | |
| | vs. sales executive in | |
| | Australia) | |
| 2. What is | Not a consumer-facing | N/A |
| the consumer | process | |
| engagement for | Via emails and/or phone | Design and implement |
| this process? | calls | to a more engaged |
| | | experience by |
| | | leveraging a website or |
| | | portal specific to the |
| | | needs of the process. |
| | Via emails, phone calls, | Get to a seamless omni- |
| | website, portal, and/or | channel experience |
| | desktop application | including mobile or |
| | | virtual assistant. |
| | Via emails, phone calls, | N/A |
| | website, portal, desktop | |
| | application, mobile | |
| | application, and/or | |
| | virtual assistant | |
| | with a seamless omni- | |
| | channel hand-off | |
| 3. How does | Not a consumer-facing | N/A |
| the consumer | process | |
| rate this | Experience not tracked | Design and implement |
| process? | | consumer experience |
| | | ratings to understand |
| | | how the consumer feels |
| | | about the process. |
| | Bad experience | Design a more intuitive, |
| | Meets needs | seamless and engaging |
| | | experience. |
| | Easy and engaging | Design a more proactive |
| | | experience. |
| | Proactive | N/A |
| 4. How does | Experience not tracked | Design and implement |
| the fulfiller | | fulfiller experience |
| rate this | | ratings to understand |
| process? | | how the fulfiller feels |
| | | about performing the |
| | | process. |
| | Bad experience | Design more intuitive, |
| | Meets needs | seamless and engaging |
| | | fulfiller experience. |
| | Easy and engaging | Design a more proactive |
| | | fulfiller experience. |
| | Proactive | N/A |

### VII. Example Graphical User Interfaces

For enterprises with a number of departments or divisions, each with a number of functions, the digital maturity assessments can be displayed using a visual heat map. Doing so provides a way for a user to rapidly determine the digital maturity of a large number of functions, and to easily identify functions with low digital maturity. For these identified functions, recommendations can be made so that the respective digital maturities can be increased.

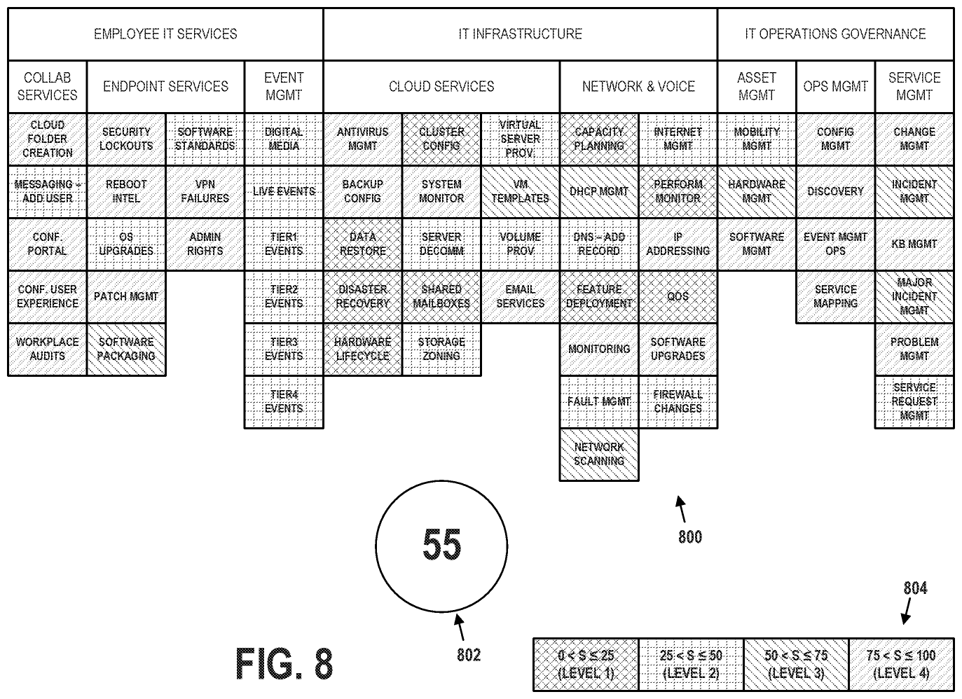

FIG. 8 depicts such a heat map 800 for IT functions. The functions have been grouped into three main categories, employee IT services, IT infrastructure, and IT operations governance. Other groupings are possible.

Employee IT services has been divided into collaboration services, endpoint services, and event management. IT infrastructure has been divided into cloud services and network & voice. IT operations governance has been divided into asset management, operations management, and service management. Other subcategories are possible. Nonetheless, within each subcategory is a list of functions represented as blocks, each appearing under their respective subcategory.

Each block contains the name of its function and a pattern signifying the assessed digital maturity level of the function. Key 804 provides a mapping of the digital maturity score, S, to the patterns. Thus, a pattern with upward diagonal hash marks represents a level 4 score, a pattern with downward diagonal hash marks represents a level 3 score, a pattern with vertical and horizontal hash marks represents a level 2 score, and a pattern with both upward and downward diagonal hash marks represents a level 1 score.

On a graphical user interface, these patterns may appear as color-coded backgrounds that represent the digital maturity levels. For instance, level 1 functions may be colored red, level 2 functions may be colored orange, level 3 functions may be colored yellow, and level 4 functions may be colored green. Nonetheless, other ways of visually signifying digital maturity levels may exist.

Overall score 802 represents a general score that is based on the individual scores of each function depicted in heat map 800. This, may be an average or weighted average of the individual scores, for example. Although not shown in FIG. 8, overall score 802 may also be hashed or color-coded in accordance with key 804.

### VIII. Example Operations

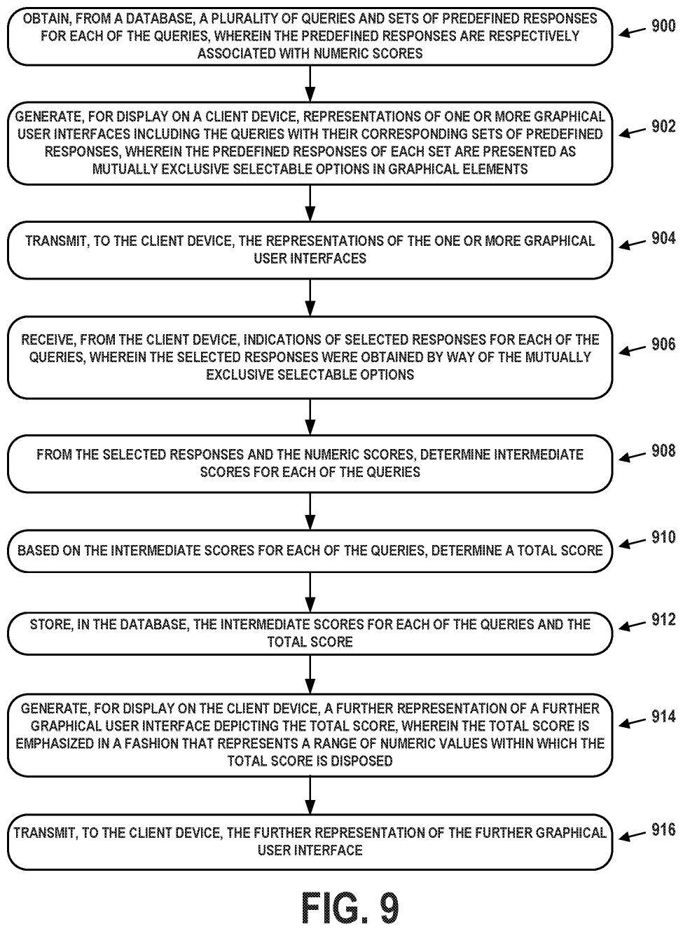

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve obtaining, from a database, a plurality of queries and sets of predefined responses for each of the queries, wherein the predefined responses are respectively associated with numeric scores.

Block 902 may involve generating, for display on a client device, representations of one or more graphical user interfaces including the queries with their corresponding sets of predefined responses, wherein the predefined responses of each set are presented as mutually exclusive selectable options in graphical elements.

Block 904 may involve transmitting, to the client device, the representations of the one or more graphical user interfaces.

Block 906 may involve receiving, from the client device, indications of selected responses for each of the queries, wherein the selected responses were obtained by way of the mutually exclusive selectable options.

Block 908 may involve, from the selected responses and the numeric scores, determining intermediate scores for each of the queries.

Block 910 may involve, based on the intermediate scores for each of the queries, determining a total score.

Block 912 may involve storing, in the database, the intermediate scores for each of the queries and the total score.

Block 914 may involve generating, for display on the client device, a further representation of a further graphical user interface depicting the total score, wherein the total score is emphasized in a fashion that represents a range of numeric values within which the total score is disposed.

Block 916 may involve transmitting, to the client device, the further representation of the further graphical user interface.

In some embodiments, the queries are arranged in a plurality of categories, and determining the total score comprises, for the categories, determining respective category scores, wherein each respective category score is based on the intermediate scores for each of the queries in the corresponding category.

In some embodiments, the plurality of categories relate to a process and include: a velocity category representing a level of execution speed for the process, an intelligence category representing a level of data availability and quality for the process, and an experience category representing a level of customization and personalization for the process.

In some embodiments, the plurality of categories also include a frequency category representing how often the process is carried out.

In some embodiments, the total score presents a digital maturity level of the process.

In some embodiments, determining the respective category scores involves determining, as each of the respective category scores, an average or weighted average of the intermediate scores for each of the queries in the corresponding category.

In some embodiments, the total score is an average or weighted average of the respective category scores.

In some embodiments, the mutually exclusive selectable options are represented in dropdown menus or radio buttons.

In some embodiments, the total score falls within a predefined range of values, and wherein the predefined range of values is divided into non-overlapping subranges, the non-overlapping subranges respectively associated with levels of success.

In some embodiments, a particular non-overlapping subrange of the non-overlapping subranges includes the total score and is associated with a particular level of success of the levels of success, and wherein the total score being emphasized comprises the further graphical user interface indicating that the total score is associated with the particular level of success.

In some embodiments, the levels of success are color-coded, each with different colors, wherein the total score being emphasized further comprises the total score being depicted on the further graphical user interface with a foreground or background including a color that corresponds to the particular level of success.

In some embodiments, the total score is one of a plurality of total scores depicted on the further graphical user interface, wherein the each of the total scores are depicted with foregrounds or backgrounds including colors that correspond to associated levels of success.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a database containing a plurality of queries and sets of predefined responses for each of the queries, wherein the predefined responses are respectively associated with numeric scores; and
one or more processors configured to:
generate, for display on a client device, representations of one or more graphical user interfaces including the queries with their corresponding sets of predefined responses, wherein the predefined responses of each set are presented as mutually exclusive selectable options in graphical elements;
transmit, to the client device, the representations of the one or more graphical user interfaces;
receive, from the client device, indications of selected responses for each of the queries, wherein the selected responses were obtained by way of the mutually exclusive selectable options;
from the selected responses and the numeric scores, determine intermediate scores for each of the queries;
based on the intermediate scores for each of the queries, determine a total score;
store, in the database, the intermediate scores for each of the queries and the total score;
generate, for display on the client device, a further representation of a further graphical user interface depicting the total score, wherein the total score is emphasized in a fashion that represents a range of numeric values within which the total score is disposed; and
transmit, to the client device, the further representations of the further graphical user interface.

2. The system of claim 1, wherein the queries are arranged in a plurality of categories, wherein determining the total score comprises:
for the categories, determining respective category scores, wherein each respective category score is based on the intermediate scores for each of the queries in the corresponding category.

3. The system of claim 2, wherein the plurality of categories relate to a process and include: a velocity category representing a level of execution speed for the process, an intelligence category representing a level of data availability and quality for the process, and an experience category representing a level of customization and personalization for the process.

4. The system of claim 3, wherein the plurality of categories also include a frequency category representing how often the process is carried out.

5. The system of claim 3, wherein the total score presents a digital maturity level of the process.

6. The system of claim 2, wherein determining the respective category scores comprises:
determining, as each of the respective category scores, an average or weighted average of the intermediate scores for each of the queries in the corresponding category.

7. The system of claim 2, wherein the total score is an average or weighted average of the respective category scores.

8. The system of claim 1, wherein the mutually exclusive selectable options are represented in dropdown menus or radio buttons.

9. The system of claim 1, wherein the total score falls within a predefined range of values, and wherein the predefined range of values is divided into non-overlapping subranges, the non-overlapping subranges respectively associated with levels of success.

10. The system of claim 9, wherein a particular non-overlapping subrange of the non-overlapping subranges includes the total score and is associated with a particular level of success of the levels of success, and wherein the total score being emphasized comprises the further graphical user interface indicating that the total score is associated with the particular level of success.

11. The system of claim 10, wherein the levels of success are color-coded, each with different colors, and wherein the total score being emphasized further comprises the total score being depicted on the further graphical user interface with a foreground or background including a color that corresponds to the particular level of success.

12. The system of claim 10, wherein the total score is one of a plurality of total scores depicted on the further graphical user interface, wherein the each of the total scores are depicted with foregrounds or backgrounds including colors that correspond to associated levels of success.

13. A computer-implemented method comprising:
obtaining, from a database, a plurality of queries and sets of predefined responses for each of the queries, wherein the predefined responses are respectively associated with numeric scores;
generating, for display on a client device, representations of one or more graphical user interfaces including the queries with their corresponding sets of predefined responses, wherein the predefined responses of each set are presented as mutually exclusive selectable options in graphical elements;
transmitting, to the client device, the representations of the one or more graphical user interfaces;
receiving, from the client device, indications of selected responses for each of the queries, wherein the selected responses were obtained by way of the mutually exclusive selectable options;
from the selected responses and the numeric scores, determining intermediate scores for each of the queries;
based on the intermediate scores for each of the queries, determining a total score;
storing, in the database, the intermediate scores for each of the queries and the total score;
generating, for display on the client device, a further representation of a further graphical user interface depicting the total score, wherein the total score is emphasized in a fashion that represents a range of numeric values within which the total score is disposed; and
transmitting, to the client device, the further representations of the further graphical user interface.

14. The computer-implemented method of claim 13, wherein the queries are arranged in a plurality of categories, wherein determining the total score comprises:
for the categories, determining respective category scores, wherein each respective category score is based on the intermediate scores for each of the queries in the corresponding category.

15. The computer-implemented method of claim 14, wherein the plurality of categories relate to a process and include: a velocity category representing a level of execution speed for the process, an intelligence category representing a level of data availability and quality for the process, and an experience category representing a level of customization and personalization for the process.

16. The computer-implemented method of claim 15, wherein the plurality of categories also include a frequency category representing how often the process is carried out.

17. The computer-implemented method of claim 14, wherein determining the respective category scores comprises:
determining, as each of the respective category scores, an average or weighted average of the intermediate scores for each of the queries in the corresponding category.

18. The computer-implemented method of claim 13, wherein the total score falls within a predefined range of values, and wherein the predefined range of values is divided into non-overlapping subranges, the non-overlapping subranges respectively associated with levels of success.

19. The computer-implemented method of claim 18, wherein a particular non-overlapping subrange of the non-overlapping subranges includes the total score and is associated with a particular level of success of the levels of success, and wherein the total score being emphasized comprises the further graphical user interface indicating that the total score is associated with the particular level of success.

20. An article of manufacture including a non-transitory computer-readable medium, having stored thereon program instructions that, upon execution by a computing system, cause the computing system to perform operations comprising:
obtaining, from a database, a plurality of queries and sets of predefined responses for each of the queries, wherein the predefined responses are respectively associated with numeric scores;
generating, for display on a client device, representations of one or more graphical user interfaces including the queries with their corresponding sets of predefined responses, wherein the predefined responses of each set are presented as mutually exclusive selectable options in graphical elements;
transmitting, to the client device, the representations of the one or more graphical user interfaces;
receiving, from the client device, indications of selected responses for each of the queries, wherein the selected responses were obtained by way of the mutually exclusive selectable options;
from the selected responses and the numeric scores, determining intermediate scores for each of the queries;
based on the intermediate scores for each of the queries, determining a total score;
storing, in the database, the intermediate scores for each of the queries and the total score;
generating, for display on the client device, a further representation of a further graphical user interface depicting the total score, wherein the total score is emphasized in a fashion that represents a range of numeric values within which the total score is disposed; and
transmitting, to the client device, the further representations of the further graphical user interface.
